(19) United States
(12) Patent Application Publication
(10) Pub. No.: US 2017/0175419 A1
(43) Pub. Date: Jun. 22, 2017

(54) Smart Door Lock System And Method Thereof

(71) Applicants: Inventec (Pudong) Technology Corporation, Shanghai (CN); Inventec (Beijing) Electronics Technology Co., Ltd, Beijing (CN)

(72) Inventor: Chaucer Chiu, Taipei (TW)

(21) Appl. No.: 15/073,399

(22) Filed: Mar. 17, 2016

(30) Foreign Application Priority Data
Dec. 18, 2015 (CN) 201510961153.7

(51) Int. Cl. E05B 45/06; G08B 13/02

(52) U.S. Cl. CPC E05B 45/06; G08B 13/02; E05B 2045/0695

(57) ABSTRACT

A smart door lock system and a method thereof are disclosed. In the system and method, a plurality of access time periods are generated by continuously detecting the door lock and analyzing open time of the door lock, and a prompt message is generated and transmitted to a main client for requesting confirmation when a current access time period does not exist in the access time periods, and the smart door lock further transmits the prompt message to a secondary client for requesting confirmation when the main client does not complete the confirmation within a preset time, and triggers the warning device and links with the police-citizen connection system for alert when the secondary client does not complete the confirmation within the preset time. Therefore, the technical effect of improving the security and the setting convenience of the smart door lock can be achieved.

### CROSS-REFERENCE TO RELATED APPLICATION

This application claims the benefit of Chinese Patent Application No. 201510961153.7, filed Dec. 18, 2015.

### BACKGROUND OF THE INVENTION

Field of the Invention

The present disclosure relates to a door lock system and a method thereof, more particularly to a smart door lock system capable of transmitting a prompt message for requesting confirmation when an abnormal access time period occurs, and a method thereof.

Description of the Related Art

In recent year, as the concept of smart home becomes popular and is rapidly developed, various smart door locks are springing up.

Generally speaking, the smart door lock can be unlocked by a manner of password or access card. However, the password of the smart door lock is guessed or cracked easily, for example, based on the fingerprints attached on the keys for inputting the password, someone can try all possible combinations of the keys; or, someone can directly crack the password by hacking. Similarly, the access card can be copied very easily. The conventional way of unlocking the smart door lock is lack of security.

Therefore, there are manufacturers providing an unlocking technology in cooperation with preset access time periods, and it is determined to be normal when the door lock is opened in one of the preset access time periods, and to be abnormal when the door lock is opened at a time not existing in the preset access time periods. Consequently, whatever manner the thief uses to open the door lock, the door lock starts to warn when the door lock is opened at the time not existing in the preset access time periods. Even if the thief just opens the door lock in one of the preset access time periods, there is no plenty of time for the crime because the user goes home in one of the preset access time periods very possibly. Therefore, the security of such door lock can be improved. However, in aforesaid way of using the preset access time periods, if the user's access time period is changed temporarily, for example, the user's work time is changed, an emergency occurs or a guest visits, the door lock opened in an unexpected access time period is determined to be abnormal, which results in warning in wrong time. Such smart door lock is still inconvenient in use. Therefore, the security of the smart door lock is improved by aforesaid way of using the preset access time periods, but the problem of inconveniently setting the access time period also exists.

In conclusion, the conventional technology problems of poor convenience in setting the smart door lock and poor security have existed for a long time, and what is need is to provide an improved technology to solve the problems.

### SUMMARY OF THE INVENTION

An exemplary embodiment of the present disclosure provides a smart door lock system including a detection module, an analysis module, a confirmation module and a triggering module. The detection module is configured to continuously detect a status of a door lock by using a sensor, and the status of the door lock comprising an unlocking status and a locking status. The analysis module is configured to analyze a time range of the unlocking status of the door lock, to generate at least one access time period. The confirmation module is configured to generate a prompt message and transmit the prompt message to a main client for requesting confirmation when a current access time period does not exist in the at least one access time period (also known as the previous access time period), and further transmit the prompt message to at least one secondary client for requesting the confirmation within a preset time when the main client does no complete the confirmation within the preset time. The triggering module is configured to trigger a warning device and link with a police-citizen connection system for alert when the main client and the at least one secondary client do not complete the confirmation within the preset time.

An exemplary embodiment of the present disclosure provides a smart door lock method including following steps: continuously detecting a status of a door lock by using a sensor, wherein the status of the door lock comprising an unlocking status and a locking status; analyzing a time range of the unlocking status of the door lock to generate at least one access time period; generating a prompt message and transmitting the prompt message to a main client for requesting confirmation when a current access time period does not exist in the access time period, and transmitting the prompt message to at least one secondary client for requesting confirmation within a preset time when the main client does not complete the confirmation within the preset time; and triggering a warning device and linking with a police-citizen connection system for alert when the main client and the at least one secondary client do not complete the confirmation within the preset time.

The difference between the system and method of the present disclosure and the conventional technology is that in the system and method of the present disclosure the plurality of access time periods are generated by continuously detecting the door lock and analyzing the open time of the door lock, and the prompt message is generated and transmitted to the main client for requesting confirmation when the current access time period does not exist in the previous access time periods, and the smart door lock further transmits the prompt message to the secondary client for requesting confirmation when the main client does not complete the confirmation within the preset time, and triggers the warning device and links with the police-citizen connection system for alert when the secondary client also does not complete the confirmation within the preset time.

By means of the technology of the present disclosure, the technical effects of improving the security and the setting convenience of the smart door lock can be achieved.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a block diagram of a smart door lock system in accordance with the present disclosure.

FIG. 2 is a flow chart of a smart door lock method in accordance with the present disclosure.

FIG. 3 is a schematic view of transmitting the prompt message, in accordance with the present disclosure.

FIG. 4 is a schematic view of the prompt message, in accordance with the present disclosure.

### DETAILED DESCRIPTION

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

Before the description of the smart door lock system and the method of the present disclosure, some nouns defined in the present disclosure are illustrated first. A main client of the present disclosure means a computing device, such as a personal computer, a tablet computer, a notebook computer, a smartphone and so on, carried by a householder of tenants lived in a house. A secondary client means a computing device, such as a personal computer, a tablet computer, a notebook computer, a smartphone and so on, carried by family lived with the householder. In practice, the main client is one in number, and the secondary client can be multiple in number.

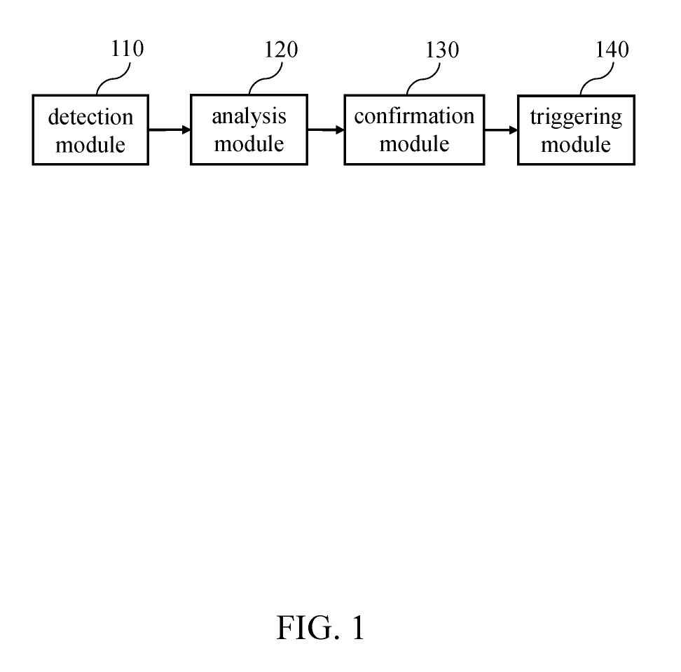

The system and method of the present disclosure will be illustrated in cooperation with drawing figures below. Please refer to FIG. 1 which shows a block diagram of a smart door lock system of the present disclosure. The smart door lock system includes a detection module 110, an analysis module 120, a confirmation module 130 and a triggering module 140. The detection module 110 is configured to continuously detect a status of a door lock by using a sensor, and the status of the door lock comprising an unlocking status and a locking status. For example, the sensor may be an infrared sensor, a magnetic sensor, or a pressure sensor. The way of using the sensor to detect the unlocking or locking statuses is a conventional technology, so the detailed description is omitted.

The analysis module 120 is configured to analyze a time range where the door lock system is in the unlocking status, to generate an access time period. In practice, each access time period includes a start time and an end time, for example, when the detection module 110 detects that the status of the door lock is changed to the unlocking status from the locking status at five past ten in the morning and the status of the door lock is back to the locking status from the unlocking status at six past ten in the morning, the analysis module 120 generates the corresponding access time period of which the start time is five past ten in the morning and the end time is six past ten in the morning. In addition, the access time period generated by the analysis module 120 can be stored in a storage device (such as a memory, a hard disk drive and so on) installed inside the door lock; alternatively, the access time period can be transmitted to a remote storage device (such as a database, a network hard disk drive, Wi-Fi memory card and so on) through wired or wireless network.

The confirmation module 130 is configured to generate a prompt message under a condition that the current access time period does not exist in previous access time period, and transmit the prompt message to a main client for requesting confirmation. If the main client does not reply the confirmation within a preset time, the confirmation module 130 further transmits the prompt message to a secondary client for requesting the confirmation within the preset time. For example, the main client can be a householder, and the secondary client can be a family member other than the householder. In practice, when the start time of the current access time period does not fall within a range between the start time and the end time of the previous access time period, the current access time period is determined to not exist in the previous access time period. For example, the start time of the current access time period is 10:07 am, and the start time and the end time of the previous access time period are 10:05 am and 10:06 am respectively, because 10:07 am is not within the range between the 10:05 am and 10:06 am, the confirmation module 130 determines that the current access time period does not exist in the previous access time period which is the access time period generated previously, and then generates the prompt message and transmits the prompt message to the main client for requesting confirmation. In practice, the prompt message includes a confirmation link, and is transmitted to the main client and the secondary client through at least one of network and SMS (Short Message Service), and the prompt message is displayed to enable the user to click the confirmation link to complete the confirmation. The way of generating the confirmation link to realize the request for confirmation is a conventional technology, so the detailed description is omitted. It should be noted that the current access time period not confirmed will be cleared and not set as the previous access time period.

The triggering module 140 is configured to trigger a warning device to link with a police-citizen connection system for alert. In practice, the warning device includes one of a loud speaker and a buzzer for outputting alert sound, and further links to the police-citizen connection system to request polices to check the client's house, so as to improve the security of the house.

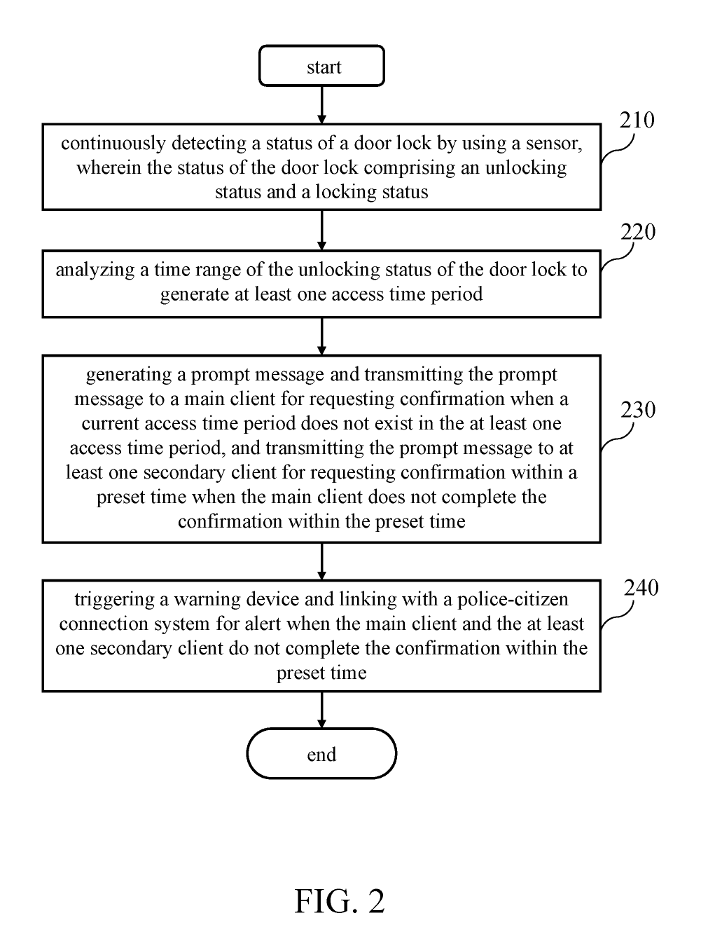

Please refer to FIG. 2 which shows a flow chart of a smart door lock method of the present disclosure. The method includes following steps. First, a sensor is used to continuously detect the status of the door lock, and the status may be the unlocking status or the locking status (step 210). The status of the door lock is analyzed to determine the time range of the unlocking status, to generate the access time period (step 220). If the current access time period does not exist in the previous access time periods, the prompt message is generated and transmitted to the main client for requesting confirmation, and the prompt message is further transmitted to the secondary client for requesting the confirmation within the preset time when the main client does not complete the confirmation within the preset time (step 230). When the main client and the secondary client both do not complete the confirmation within the preset time, the warning device is triggered and linked to the police-citizen connection system for alert (step 240). Through aforesaid steps, the plurality of access time periods can be generated by continuously detecting the door lock and analyzing the open time of the door lock, and the prompt message can be generated and transmitted to the main client for requesting confirmation when the current access time period does not exist in the previous access time periods, and the smart door lock further transmits the prompt message to the secondary client for requesting the confirmation when the main client does not complete the confirmation within the preset time, and triggers the warning device and links with the police-citizen connection system for alert when the main client and the secondary client both do not complete the confirmation within the preset time.

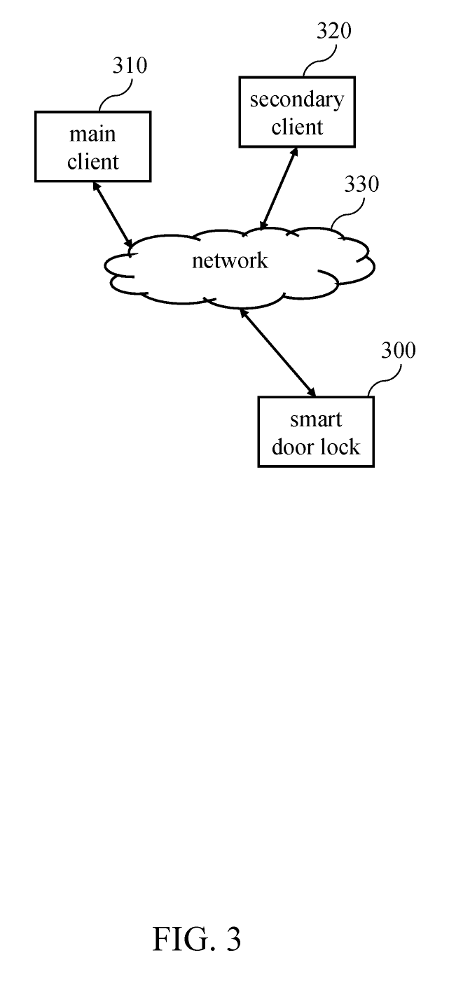

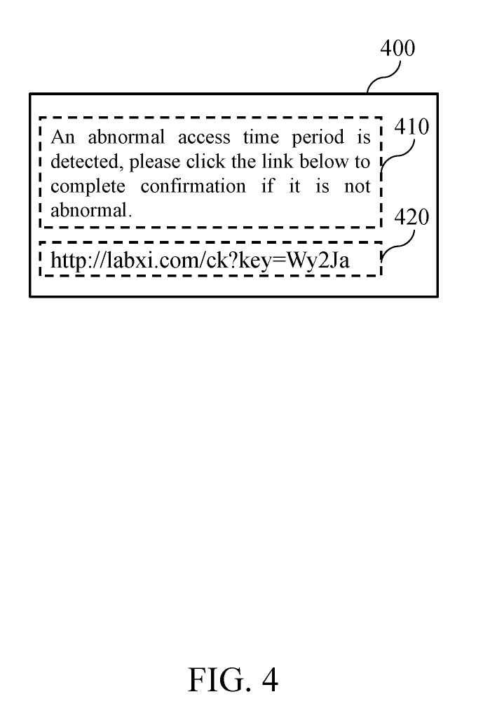

An embodiment is illustrated in cooperation with FIGS. 3 and 4 below. Please refer to FIG. 3 which shows a schematic view of transmitting the prompt message, in accordance with the present disclosure. In practice, the smart door lock 300 of the present disclosure will transmit the prompt message in two conditions. In a first condition, the prompt message is transmitted to a main client 310 through network 330; in a second condition, the prompt message is transmitted to a secondary client 320 through the network 330 when the main client 310 does not complete the confirmation within the preset time. It should be particularly noted that the prompt message is transmitted to all secondary clients 320 when the secondary client 320 is multiple in number. Preferably, the network 330 may be mobile communication network or interne network and configured to transmit at least one of SMS and email. Consequently, the access time period can be automatically set based on the confirmation of the main client 310 or the secondary client 320 without presetting. Therefore, when the smart door lock is opened in an unexpected access time period which does not exist in the previous access time periods, for example, the work time is change, an emergency occurs or a guest visits, and the unlocking status can be prevented from being determined as abnormal, so that the smart door lock of the present disclosure can effectively prevent from warning in wrong time to cause inconvenience in use.

Please refer to FIG. 4 which shows a schematic view of the prompt message of the present disclosure. In practice, the prompt message 400 includes captions 410, such as “An abnormal access time period is detected, please click the link below to complete confirmation if it is not abnormal.”, and a link 420 for confirmation, such as “http://labxi.com/ck?key=Wy2Ja”. Upon receipt of the prompt message 400, a user near the main client 310 or the secondary client 320 can click the link 420 for confirmation, so as to reply the confirmation module 130 that the confirmation is completed.

In conclusion, the difference between the system and method of the present disclosure and the conventional technology is that the plurality of access time periods are generated by continuously detecting the door lock and analyzing the open time of the door lock, and the prompt message is generated and transmitted to the main client for requesting confirmation when the current access time period does not exist in the previous access time periods, and the smart door lock further transmits the prompt message to the secondary client for requesting confirmation when the main client does not complete the confirmation within the preset time, and triggers the warning device and links with the police-citizen connection system for alert when the secondary client does not complete the confirmation within the preset time. By means of the technology of the present disclosure, the conventional technology can be solved and the technical effects of improving the security and the setting convenience of the smart door lock can be achieved.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A smart door lock system, comprising:
a detection module configured to continuously detect a status of a door lock by using a sensor, wherein the status of the door lock comprising an unlocking status and a locking status;
an analysis module configured to analyze a time range of the unlocking status of the door lock, to generate at least one access time period;
a confirmation module configured to generate a prompt message and transmit the prompt message to a main client for requesting confirmation when a current access time period does not exist in the at least one access time period, and further transmit the prompt message to at least one secondary client for requesting the confirmation within a preset time when the main client does no complete the confirmation within the preset time; and
a triggering module configured to trigger a warning device and link with a police-citizen connection system for alert when the main client and the at least one secondary client do not complete the confirmation within the preset time.

2. The smart door lock system according to claim 1, wherein the sensor comprises an infrared sensor, a magnetic sensor or a pressure sensor.

3. The smart door lock system according to claim 1, wherein each of the at least one access time period comprises a start time and an end time, and when the start time of the current access time period is not within a range from the start time and the end time of the at least one access time period, the current access time period is determined to not exist in the at least one access time period.

4. The smart door lock system according to claim 1, wherein the prompt message comprises a confirmation link, and is transmitted to the main client and the at least one secondary client through at least one of network and SMS, for display and enabling the confirmation to be completed by clicking the confirmation link.

5. The smart door lock system according to claim 1, wherein the warning device comprises one of a loudspeaker and a buzzer, to output sound for alert.

6. A smart door lock method, comprising:
continuously detecting a status of a door lock by using a sensor, wherein the status of the door lock comprising an unlocking status and a locking status;
analyzing a time range of the unlocking status of the door lock to generate at least one access time period;
generating a prompt message and transmitting the prompt message to a main client for requesting confirmation when a current access time period does not exist in the at least one access time period, and transmitting the prompt message to at least one secondary client for requesting confirmation within a preset time when the main client does not complete the confirmation within the preset time; and
triggering a warning device and linking with a police-citizen connection system for alert when the main client and the at least one secondary client do not complete the confirmation within the preset time.

7. The smart door lock method according to claim 6, wherein the sensor comprises an infrared sensor, a magnetic sensor or a pressure sensor.

8. The smart door lock method according to claim 6, wherein each of the at least one access time period comprises a start time and an end time, and when the start time of the current access time period is not within a range from a start time and an end time of the at least one access time period, the current access time period is determined to not exist in the at least one access time period.

9. The smart door lock method according to claim 6, wherein the prompt message comprises a confirmation link, and is transmitted to the main client and the secondary client through at least one of network and SMS, for display and enabling the confirmation to be completed by clicking the confirmation link.

10. The smart door lock method according to claim 6, wherein the warning device comprises one of a loudspeaker and a buzzer, to output sound for alert.
